(19) United States
(12) Patent Application Publication
(10) Pub. No.: US 2009/0222873 A1
(43) Pub. Date: Sep. 3, 2009

(54) Multimedia Channel Switching

(76) Inventor: Torbjörn Einarsson, Stockholm (SE)

Correspondence Address: NIXON & VANDERHYE, PC, 901 NORTH GLEBE ROAD, 11TH FLOOR, ARLINGTON, VA, 22203, US

(21) Appl. No.: 11/885,931

(22) PCT Filed: Dec. 30, 2005
(86) PCT No.: PCT/SE05/02067

§ 371 Date: Jan. 21, 2009

Related U.S. Application Data
(60) Provisional application No. 60/658,597, filed on Mar. 7, 2005.

(30) Foreign Application Priority Data
Jun. 17, 2005 (SE) 050144-4

(51) Int. Cl. H04N 7/173; H04J 3/22

(52) U.S. Cl. 725/115; 725/116; 370/468; 725/134

(57) ABSTRACT

The invention reduces the user-perceived time of switching multimedia channels in a unicast communications system. This shortening of the switch procedure is obtained by reducing the buffering of the multimedia data in the data buffer of a user terminal. A reduced media buffering results in that multimedia data of the new channel will be rendered in the user terminal in a much shorter period of time. A multimedia provider communicating the multimedia data to the terminal determines a reduced transmission rate that will be temporarily employed for obtaining the buffering reduction. This reduced rate is lower than the normally employed transmission rate and lower than the rendering rate of the media player of the terminal. Consequently, the terminal buffer will be emptying in a faster rate than it is replenished and a buffer level reduction is obtained.

### TECHNICAL FIELD

The present invention generally relates to management of multimedia sessions in communications systems, and in particular to reducing the user-perceived time of switching multimedia channels in such multimedia sessions.

### BACKGROUND

It has become a trend to offer and provide a vast range of new services in existing mobile networks and mobile communications systems. There is currently a very big interest in using mobile networks for multimedia or TV content. This is often referred to as Mobile-TV in the art. The goal for Mobile-TV applications is to offer a TV-like experience where the user can choose and easily zap between different multimedia or TV channels.

Ordinary TV channels are broadcasted to many users and typically the user can choose which channel to receive and view. Mobile-TV is similarly about delivering a set of (live) media or multimedia streams to several end-users. Each multimedia stream corresponds to a TV-channel, and each user shall be able to choose which channel to view. At the moment, broadcast/multicast delivery methods for Mobile-TV are under development. Examples of such standardisation efforts are 3GPP Multimedia Broadcast/Multicast Services (MBMS) and European Telecommunications Standards Institute (ETSI) Digital Video broadcasting-Handheld (DVB-H). These will be similar to traditional TV, in their broadcast distribution fashion.

In the meantime, until Mobile-TV based on multicast/broadcast is available, there is a need for solution that can be implemented over existing mobile transport channels. It will also later be of big interest for cells with few users and for networks with enough capacity, where unicast transport is the preferred distribution means.

A mobile TV-like service using streaming over Internet Protocol (IP) based networks can be implemented into existing mobile networks. An example is the Packet-Switched (PS) Streaming Service (PSS) developed in 3GPP. In order to start such a multimedia or TV session, a user typically surfs to a web page or portal and clicks on or selects a link to look at a live-streaming channel.

There also exist several proprietary streaming solutions that could be used for Mobile-TV, e.g. RealNetworks, Apple's Quicktime and Microsoft's media player. These also typically have a portal or web page where a link is clicked to start receiving a certain channel.

One of the goals of Mobile-TV services is to make it possible to zap between channels, as one can do for ordinary broadcasted TV channels. If all channels are broadcasted, the receiver can locally choose between channels by choosing the appropriate transport channel and using an appropriate demultiplexer. This is the case for standard cable, satellite or terrestrial television as well as the upcoming mobile standards MBMS and DVB-H. However, for unicast sessions, the client must instead influence a “server” or multimedia provider to send the desired channel.

The traditional way of doing IP-based mobile streaming is to choose a specified content in a browser. This starts the download of a Session Description Protocol (SDP) or a Synchronized Multimedia Integration Language (SMIL) file, which in turns initiates a Real Time Streaming Protocol (RTSP) streaming session in a media player of a user terminal. The approximate time it takes until a user sees the content on the screen of the user terminal is typically around or slightly over ten seconds of which maybe five seconds is application setup and the rest is signalling (around two seconds) and buffering (around three to four seconds). If the user wants to switch to another “multimedia or TV channel”, he must stop the current data stream and go back to the browser where he chooses another channel by clicking a link. Then, a new RTSP session is started, the media player initiates and starts to buffer, and there is a new delay of about ten seconds.

In the international application [1], a technique is presented to dramatically reduce the user-perceived time of a multimedia channel switch. This techniques, basically, allows a user to simply activate one of the user inputs of the user terminal in order to select a new multimedia channel. Multimedia data of the new channel can then be delivered directly to the user terminal without requiring the user to anew visit the multimedia provider's web page and with no new session setup procedure. However, even with this time reducing technique, a buffering of about four seconds is still performed.

### SUMMARY

There is, thus, a need for decreasing the user-perceived time when switching multimedia channels during a multimedia session in unicast (packet-switched) networks and communications systems.

The present invention overcomes these and other drawbacks of the prior art arrangements.

It is a general object of the present invention to provide a reduction in the user-perceived time of switching multimedia channels in a unicast communications system.

It is another object of the invention to provide a shorting of the channel switching procedure from the user point of view without requiring any modifications or adaptations of the employed user terminal.

It is a particular object of the invention is to provide a shortening of the channel switch procedure that can be conducted in a transparent way for the user terminal.

It is another particular object of the invention to provide a shortening of the channel switching procedure that can be used as a complement to other techniques for reducing the user-perceived time of a multimedia channel switch.

These and other objects are met by the invention as defined by the accompanying patent claims.

Briefly, the present invention involves reducing the user-perceived time of switching multimedia sources in a unicast communications system. This user-perceived switching time is due to application setup, signalling between the user terminal and the multimedia provider and buffering of the multimedia data in the user terminal prior rendering and playing out the data. The present invention reduces the buffering time portion of the total switching time. This means that, following a multimedia channel switch, the multimedia data of the new channel will be rendered and available for the user in a much shorter period of time due to the reduced buffering in the terminal.

The present invention achieves this buffering or buffer level reduction in the user terminal by determining a reduced transmission rate. This reduced transmission rate is, on average, lower than the corresponding (average) rate of transmission that is normally employed by a multimedia provider when forwarding media data to a requesting user terminal. In addition, this reduced transmission rate is lower than the rendering rate of the media player in the user terminal. This means that multimedia data will leave the buffer of the terminal faster, i.e. being rendered by the media player, faster than the buffer is replenished by new data, i.e. received from the multimedia provider. As a consequence, the buffer level in the user terminal buffer will reduce.

The multimedia provider then temporarily utilize this determined reduced transmission rate in order to decrease the buffer level of the terminal buffer and thereby allow the user-perceived reduction of the channel switch time.

For illustrative purposes, in a prior art channel switch, the media buffering in the user terminal takes about four seconds. These four seconds is typically the total user-perceived time of a multimedia channel switch performed according to the teachings of the international patent application [1]. This means that when the techniques of the present invention are applied as a complement to the switching time reduction of the document [1] to reduce the buffering time down to about second, the user-perceived time of the channel switch will decrease with about 75%.

In order to prevent the risk of buffer underrun or emptying and further to obtain a final buffer level after the buffer level reduction that is suitable for the particular user terminal, the determination of the reduced transmission rate and/or the period of time during which the reduced rate is employed can be performed at least partly based on the particular capabilities of the user terminal. In such a case, the multimedia provider preferably receives information of these buffer capabilities or at least information allowing an estimation of the capabilities from the user terminal.

Suitable parameters in this context include the initial buffer level of the user terminal, maximum buffer level, minimum buffer level and/or current level. Most of the user terminals available today utilize a pre-defined buffer level that is dependent on the terminal model. The user terminal can then inform the multimedia provider of this utilized initial buffer level. Alternatively, the terminal could be configured for utilizing a given percentage of its total buffer capacity. In such a case, transmitting notification of the maximum level to the provider can be useful in the reduced rate determination.

A user terminal is typically configured for performing a re-buffering of data in the case a minimum buffer level, which is typically zero, is reached. This means that the buffer level reduction of the present invention should preferably not result in that this minimum level is reached, otherwise the buffering time is anew increased back to the pre-defined initial level and the reduction was in vain.

The terminal could also periodically, intermittently and/or upon request transmit information of its current buffer level status to the multimedia provider. This buffer feedback can be utilized by the provider to fine tune the desired buffer level in the terminal.

Instead of transmitting data of its initial, maximum, minimum and/or current buffer level, the user terminal could, e.g. during session setup or as a part of the channel switch request, include information of its terminal model. The multimedia provider then has access to e.g. a table listing relevant buffer capacity data for the different available user terminal models. Using the received model data in a table look-up procedure will then provide the buffer level information that can be used in the reduced rate determination by the multimedia provider.

In a first embodiment of the invention, the determined reduced transmission rate is zero. This means that during a determined short period of time no new multimedia data will actually be transmitted to the user terminal. In this case, the multimedia provider temporarily drops data of the current multimedia channel as determined based on the reduced transmission rate. In a preferred implementation of this embodiment, the multimedia provider starts the session by transmitting a few packets of data using the high normal transmission rate to the user terminal. These first packets will be entered in and buffered in the data buffer of the terminal. Once the buffering procedure has started, the provider then drops all multimedia data packets for a determined period of time. This means that no new data packets will be entered in the buffer but some of the already received data packets will leave the buffer and be rendered. The buffer level will, thus, be reduced. When an appropriate reduced buffer level is obtained, the multimedia provider anew starts sending data packets to the user terminal. The reduced buffer level will then be kept and allows a much shorter channel switching if the user subsequently would like to switch multimedia channels.

This embodiment has the advantage of being very simple to implement. A drawback is that there will be a user-detectable discontinuity in the rendered data since some of the data of the multimedia channel will be missing. This drawback can be minimized by dropping less useful data. For example, the multimedia provider can start the data transmission of channel by sending coefficientless P-pictures and silent audio to the terminals. In such a case, dropping data packets containing this type of data will not be experienced by the user.

Another embodiment of the invention performs the buffer reduction in connection with a channel switch request from the user terminal. Following this channel switch, instead of directly delivering data packets of the new requested channel to the user terminal, the multimedia provider temporarily skips transmitting new data of the requested channel. During this transmission silence, the data packets of the old data channel and found in the terminal buffer will be rendered and thereby resulting in a buffering reduction.

In this embodiment, the first channel switch takes the same long time as employing the prior art techniques. However after the first switch has been performed, the buffer level of the user terminal has been reduced. This means that any further channel switch will be performed in a much shorter period of time since the buffering of data during the switch is reduced.

This embodiment has the advantage of being very simple to implement and the only requirement on the user terminal play-out is that it should have occurred before the first channel switch. The drawback is that the first switch is still long.

In still another embodiment of the invention, the multimedia provider temporarily transmits the multimedia data to the user terminal at the reduced transmission rate. In this case the transmission rate is non-zero but lower than the rendering rate of the media player in the user terminal and furthermore lower than the normal high transmission rate. This reduced data provision rate results in that multimedia data leaves (is rendered) the data buffer of the user terminal in a faster rate than it is being replenished. As a consequence a buffer level reduction is obtained.

For live streaming, or other cases where the (fixed) rate of the multimedia source cannot be changed, this solution requires that the data is buffered in the network instead of the user terminal. In such a case, the multimedia provider buffers multimedia data in a network buffer before transmission to the user terminal. However, data transmission from the multimedia provider is not totally choked during the temporary period of time, on the contrary the data transmission proceeds but with a reduced rate. This means that the network buffer is gradually built up simultaneous as the terminal buffer is gradually emptied.

Once an appropriate low buffer level is reached in the user terminal, the multimedia provider increases the transmission rate back, preferably close, to the rendering rate to prevent total buffer emptying. Upon reception of a channel switch request from the user terminal, the multimedia provider starts delivering data of the new request channel directly without any prior buffering in the network buffer. This means that the data of the old channel that is still present in the network buffer and has not yet been sent to the user terminal will be discarded.

The advantage of this embodiment is that there is no discontinuity in the media played at the user terminal and that already the first switch may be conducted in a shorter period of time compared to the prior art techniques.

The rendering of the media in the buffer is controlled by time stamps (or similar) that are available for each received packet containing the media or multimedia data. The initial buffering process in the user terminal will typically continue X seconds, e.g. four seconds, of wall-clock-time, but it could also be a number of bytes in the buffer, or a time difference indicated by the time stamps. Anyway, after the initial buffer period, the media player will start rendering the media with the lowest time stamp, and then follow the time stamps of further packets and play out the media. In general, the byte consumption in a time period is dependent on the coding rate (number of bits) for that time period and not the transport rate. In other words, the time stamps indicate the presentation time (play-out time) and not the arrival time/sending time of the packets.

In order to keep the reduced transmission rate below the rendering rate and also perform the buffer level reduction in a transparent manner for the media player of the user terminal even in the case of data dropping, the multimedia provider preferably assigns time stamps to the transmitted data packets so that a continuous time stamping is obtained. Also the sequence number of the transmitted packets of multimedia data can be set to obtain a continuous and contiguous sequence numbering. In such a case, the media player will not notice that any data packets have been dropped, skipped or delayed in the multimedia provider. The continuous time stamping causes the media player of the terminal to perform the media rendering in a same continuous rate that will not be affected by the buffer level reduction embodiments of the present invention.

The invention offers the following advantages:
Reduces the user-perceived time when switching multimedia channels;
Gives a much improved channel “zapping” experience;
Requires no modifications, changes or control of the user terminal;
Can be utilized as a complement to other channel switch time reducing techniques;
Provides a buffer level and channel switch time reduction without any impact on the media player and data rendering in the user terminal; and
The present invention is very easy to implement and requires few modifications to existing network units.

Other advantages offered by the present invention will be appreciated upon reading of the below description of the embodiments of the invention.

### SHORT DESCRIPTION OF THE DRAWINGS

The invention together with further objects and advantages thereof, may best be understood by making reference to the following description taken together with the accompanying drawings, in which:

FIG. 1 is a diagram illustrating cumulative number of bytes received and rendered as a function of time according to prior art techniques;

FIG. 2 is a flow diagram illustrating a method of reducing a user-perceived switching time according to an embodiment of the present invention;

FIG. 3 is a flow diagram illustrating different embodiments of additional steps of the method of FIG. 2 in more detail;

FIG. 4 is a flow diagram illustrating the time reducing step of FIG. 2 in more detail according to an embodiment of the present invention;

FIGS. 5 and 6 schematically illustrate the principles of renumbering data packets and assigning time stamps according to the embodiment of the present invention disclosed in FIG. 4;

FIG. 7 is a diagram illustrating cumulative number of bytes received and rendered as a function of time according to the embodiment of the present invention disclosed in FIG. 4;

FIG. 8 is a flow diagram illustrating the time reducing step of FIG. 2 in more detail according to another embodiment of the present invention;

FIG. 9 is a flow diagram illustrating the time reducing step of FIG. 2 in more detail according to a further embodiment of the present invention;

FIG. 10 schematically illustrates the principles of assigning time stamps according to the embodiment of the present invention disclosed in FIG. 9;

FIG. 11 is a diagram illustrating cumulative number of bytes received and rendered as a function of time according to the embodiment of the present invention disclosed in FIG. 9;

FIG. 12 is a flow diagram illustrating the time reducing step of FIG. 2 in more detail according to yet another embodiment of the present invention;

FIG. 13 schematically illustrates the principles of assigning time stamps according to the embodiment of the present invention disclosed in FIG. 12;

FIG. 14 is a diagram illustrating cumulative number of bytes received and rendered as a function of time according to the embodiment of the present invention disclosed in FIG. 12;

FIG. 15 is a schematic overview of an embodiment of a communications system according to the present invention;

FIG. 16 is a schematic overview of another embodiment of a communications system according to the present invention;

FIG. 17 is a schematic block diagram of a multimedia provider according to an embodiment of the present invention;

FIG. 18 is a schematic block diagram of the rate adapter of the multimedia provider in FIG. 17 according to an embodiment of the present invention;

FIG. 19 is a schematic block diagram of the rate adapter of the multimedia provider in FIG. 17 according to another embodiment of the present invention;

FIG. 20 is a schematic block diagram of the rate adapter of the multimedia provider in FIG. 17 according to a further embodiment of the present invention;

FIG. 21 is a schematic block diagram of a multimedia provider according to another embodiment of the present invention; and

FIG. 22 is a schematic block diagram of a user terminal according to an embodiment of the present invention.

### DETAILED DESCRIPTION

Throughout the drawings, the same reference characters will be used for corresponding or similar elements.

The present invention relates to management of multimedia sessions in unicast communications systems and in particular to methods and arrangements for reducing a user-perceived time when switching multimedia channels in such systems.

In traditional unicast Internet Protocol (IP) based wireless communications systems, when a user wants to switch media or multimedia channel during a multimedia session, he/she typically has to visit a web site hosted by a content or service provider by means of a web browser or other application of his/her user terminal. A new application session setup is performed which may take about five seconds on most typical user terminals, or about seven seconds if the signaling between the user terminal and content provider and/or streaming server is included. To these about seven seconds is about four seconds of buffering of the multimedia data in the user terminal added. This means that the total delay or lag perceived by the user terminal following a channel switch is about or slightly above ten seconds, of which about 40% is due to the data buffering in the user terminal.

In the international application [1], a solution is presented that removes the prior art need for visiting a web site and setting up a new application session during a multimedia channel switch. However, although this technique drastically reduces the total user-perceived time of a channel switch, the about four seconds of data buffering in the user terminal still remains.

The present invention reduces this total user-perceived delay or lag following a channel switch by deliberately lowering the buffer level or buffering time in the user terminal. As a result, when a subsequent multimedia switch occurs, the multimedia will be rendered and data will appear much quicker on the graphical user interface of the user terminal.

The basic idea of the invention to achieve this buffer level reduction is to temporarily lower the multimedia transmission rate or speed and keep it lower than the play-out or rendering rate or speed of the user terminal. This will result in that data is temporarily exited (i.e. rendered) from the user terminal buffer faster than it is replenished (i.e. received from the multimedia provider) and the buffer level will be reduced. Thereafter the multimedia data transmission rate is increased, e.g. returned to the previous relatively higher rate, to prevent total depletion of the data in the buffer.

A typical example in this context could be to reduce the buffer level in the user terminal from about four seconds of data buffering to about one second of buffering. This will then result in a total decrease of the delay in media rendering after a channel switch with about 75% compared to the switching time obtainable according to the techniques of the document [1], which will be a perceptible positive difference for the user compared to the prior art solutions.

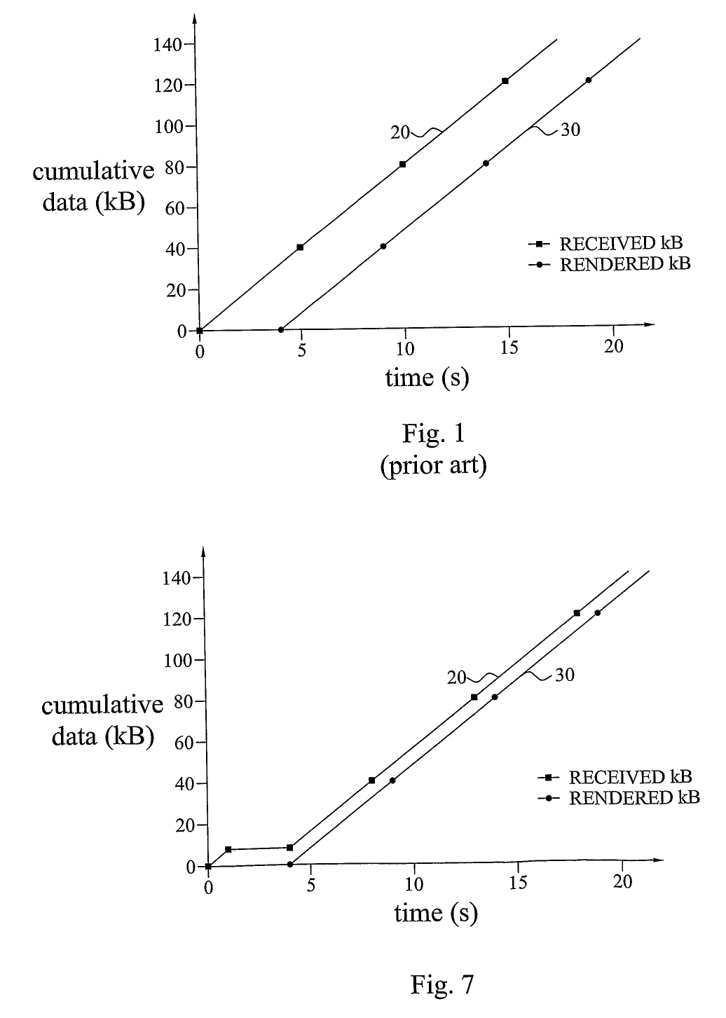

A common way of describing buffering status in a streaming user terminal is to draw a diagram showing the cumulative number of bytes received and played out as a function of time. The difference between the received number of bytes and the played-out number of bytes at a given time is the buffer fullness level. In order to make the diagram visually simple, it is henceforth, non-limitedly, assumed that the typical reception rate and rendering or play-out rate are both constant, and are exemplified by 8 kB/s. This should however only be seen as a non-limiting illustrative example. FIG. 1 schematically illustrates these principles according to the prior art solution with an initial (constant) buffering of four seconds.

In the figure, the curve 20 with filled squares represents the amount of received multimedia data, which reflects the average transmission rate of the multimedia provider. The curve 30 with filled circles, correspondingly, represents the amount of multimedia data rendered by the multimedia player of the user terminal. Note that the difference in FIG. 1 between the upper curve 20 and the lower curve 30 is constant and exactly 32 kB for the initial buffering time of four seconds. In this FIG. 1 and in the corresponding diagrams of the invention discussed further below, the vertical difference between the lines corresponds to the buffer fullness in bytes at a given time instance. The horizontal difference between the lines corresponds to the buffer fullness in time at a given buffer level.

If a channel switch is triggered, the multimedia data of the new channel will also be buffered in the user terminal before rendering and (visually and/or audibly) accessible for the user. As a consequence, the rendering of the new data will be delayed, upon reception, for four seconds in the illustrative prior art example.

In this example and in the following diagrams, a constant coding and transport rate has been assumed, to make the drawings simpler. However the invention is not limited thereto. In practice, the rendering curve 30 will not have a constant distance to the reception curve 20. Even for constant transmission rate, there will be jitter that results in a varying reception rate. However, the average difference between the reception curve and rendering curve, i.e. the buffering time, according to the prior art techniques will be fairly constant.

The rendering of the media in the buffer is controlled by the RTP (Real Time Protocol) time stamps (or similar) that are available for each received packet containing the media or multimedia data. The initial buffering process will typically continue X seconds, e.g. four seconds, of wall-clock-time, but it could also be a number of bytes in the buffer, or a time difference indicated by the RTP time stamps. Anyway, after the initial buffer period, the media player will start to render the media with the lowest time stamp, and then follow the time stamps of further packets and play out the media. In general, the byte consumption in a time period is dependent on the coding rate (number of bits) for that time period and not the transport rate. In other words, the time stamps indicate the presentation time (play-out time), and not the arrival time/sending time of the packets.

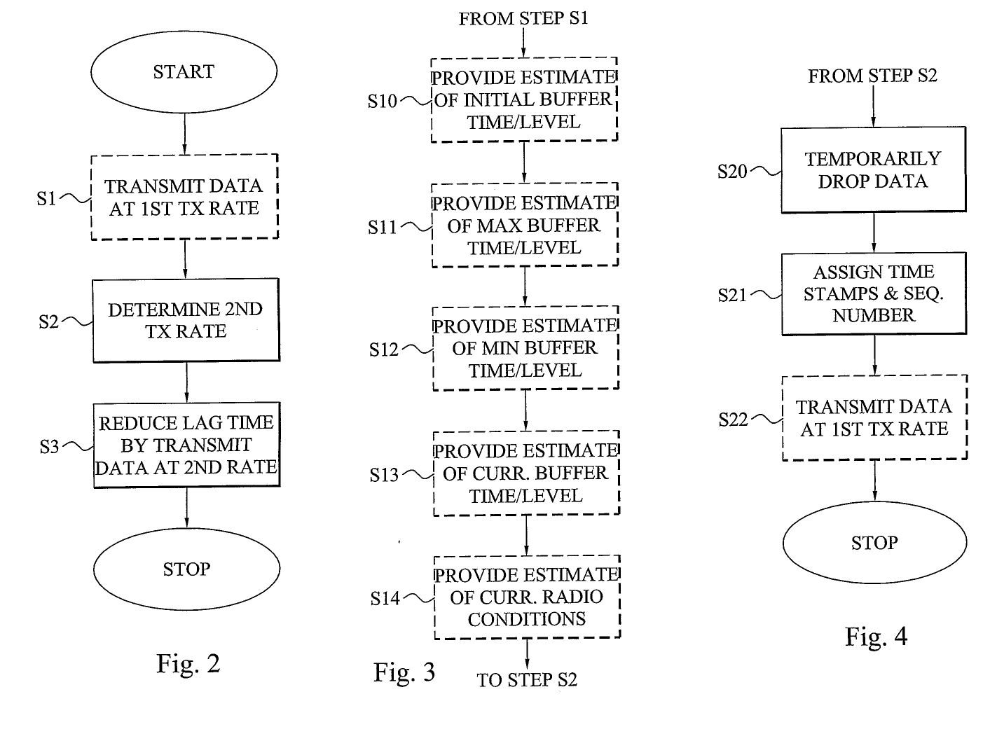

FIG. 2 is a flow diagram of a method of reducing the user-perceived time of a switch of multimedia channels in a unicast communications system according to the present invention. The method starts in the optional step S1, in which the multimedia or content provider transmits multimedia data of a first or current multimedia channel to a user terminal at a first or current transmission rate. In the present invention, “transmission rate” is defined as the amount of data (e.g. number of bytes of data) that is sent per time unit to a user terminal. In the user terminal, the multimedia data is buffered before rendering and play-out in order to provide a safety margin to variations in transport quality (radio conditions) as well as for accommodating variations in the coding rate of the data.

In a next step S2, the multimedia provider determines a second transmission rate for the current multimedia session. This second transmission rate is lower than the first transmission rate and furthermore lower than the multimedia data rendering or play-out rate of the user terminal. As a consequence, by temporarily employing this lower transmission rate, the multimedia provider can reduce the buffer level of the user terminal.

The multimedia provider, thus, actively reduces the lag or delay time of rendering multimedia data of a second or new data channel in the user terminal following a possible channel switch from the first (current) channel to the second (new) multimedia channel by temporarily employing the second transmission rate to decrease the buffer level of the user terminal in step S3. This means that the multimedia provider temporarily provides or transmits multimedia data to the user terminal at the lower second transmission rate. As is well known to the person skilled in the art, a transmission rate could be 0 bytes per second, which implies that no data is actually transmitted during a temporary period of time. As a consequence, according to the present invention, the expression “temporarily transmitting multimedia data at the determined second transmission rate” implies that less or even none multimedia data is transmitted to the user terminal during a period of time compared to if the first transmission rate instead would be used. Generally, in this context, if the first transmission rate is X kB/s and the second transmission rate is Y kB/s, 0≦y<X and Y<Z, where Z is the rendering rate (kB/s) of the media player in the user terminal. Furthermore, X is typically, on average, equal to Z or larger than Z.

Note though that the user will typically not experience the change in transmission rate, even if the transmission rate is temporarily reduced to zero, since the media player will continue to render the multimedia data already stored in the buffer. As a consequence, the buffer level reduction of the present invention employed as means for reducing the lag time of channel switches does generally not causes any noticeable drawbacks for the relevant user.

Once a desired lower buffer level is obtained, the multimedia data is anew transmitted at a higher transmission rate, e.g. the first transmission rate or a third transmission rate by the multimedia provider. In the latter case, the third transmission rate could be larger than the first rate or lower than the first rate but higher than the second transmission rate.

If the user now wants to switch multimedia channel, data of the new channel can be rendered in a much shorter period of time following reception in the user terminal due to the shorter buffering of the data. For example, an initial buffer level of four seconds can be reduced by employing the present invention down to about one second of data buffering.

The second transmission rate and/or the period of time during which it is employed by the multimedia provider can be determined by the provider as a compromise between two conflicting goals. Firstly, as a low buffer level as possible is desired from the user point of view since this reduces the lag time of rendering the multimedia data after a channel switch. Thus, a lower buffering will result in a shorter perceived channel switch time and faster play-out of the new media. Secondly, a too low buffer level may, due to variations in coding rate and transport (radio) conditions, result in buffer underrun, i.e. emptying the data buffer. In such a case, the user terminal typically re-buffers data back to the original (large) buffer level, e.g. back to four seconds of buffering. As a consequence, the deliberate lowering of the buffer level was then in vain.

This means that the buffer level of the user terminal is preferably reduced as much as possible according to the present invention down to a margin that is enough to cope with slight variations in coding rate and transport conditions without requiring re-buffering, which is discussed further below.

The method then ends.

The buffer level reducing techniques of the present invention is preferably employed as a complement to other switching time reducing techniques, e.g. as present in the international application [1]. Briefly, when a user would like to watch a multimedia channel available from a content or multimedia provider, he/she sends a request for this multimedia channel to the provider. This channel request is typically generated by the user visiting a web page of the multimedia provider and clicking on a link associated with the multimedia channel. The multimedia provider then automatically generates a multimedia session set-up description comprising all the information, objects and instructions needed for enabling a user-friendly switch to any of the alternative channels without requiring the user to end the ongoing session and anew visit the multimedia provider's web page.

The generated set-up description is returned to the user terminal, where the included data objects of the description are processed by the terminal. Firstly, a multimedia object of the description defines, when processed in the terminal, a multimedia session window that is displayed on a screen or graphical user interface (GUI) in the terminal. This session window includes a display region adapted for displaying multimedia (video) data of a requested channel. The window further includes a displayable channel region that includes information on the alternative multimedia channels available from the provider. This information could e.g. be identifiers or icons of the TV-programs or movies that are currently available on these alternative channels. This means that the user will have access to information about all these different multimedia channels in the display screen already at the start of the session. As a consequence, the user does not have to end the session and anew visit the multimedia provider's web page to obtain this kind of information.

An association object of the session set-up description defines, when processed in the terminal, an association or binding between user inputs of the terminal and identifiers of the alternative channels, which are announced in the channel region of the session window. The user inputs that are associated with the channel identifiers can e.g. be keys of a keypad in the terminal or portions of a touch sensitive screen. A request object of the set-up description generates, upon a user-triggering of one of the user inputs, a request for the alternative channel, the identifier of which is associated with the triggered user input. This channel switch request is then automatically transmitted to the multimedia provider that performs the channel switch without any more intervention from the user.

In other words, when the user wants to switch multimedia channel he/she e.g. simply pushes one of the keys on the user terminal that has been assigned for this channel. The channel region, in addition to listing information on the available alternative channels, preferably also identifies those keys (user inputs) that have been assigned to the alternative channels. When the relevant key is pushed, the request object compiles the channel switch request. This switch request comprises the identifier of the requested channel which is obtained through the key binding provided by the association object. In addition, the request comprises an identifier of the user terminal in order to allow the multimedia provider to identify the relevant terminal.

This means that the only procedure that the user needs to perform to switch multimedia channel during a session according to the document [1] is to, by means of the displayed channel region, identify which user input (key) that is associated with and assigned to the desired channel and then activate this user input. This should be compared to the prior art solutions for unicast systems, in which the user first have to end the current session, anew visit the provider's web page to select and click on the link to the desired multimedia channel. Thereafter a new session set-up procedure has to be performed, leading to a very time-consuming and cumbersome channel switch procedure.

When the multimedia provider receives the channel switch request, it identifies the new desired channel by means of the included channel identifier and then directs the multimedia data flow of this new channel to the correct user terminal using the included terminal identifier.

The total user-perceived time of a channel switch performed according to the discussion above, thus, mainly constitutes of the data buffering in the user terminal. The present invention that reduces this data buffering time is therefore a very good complement to the enhanced channel switch procedure of the document [1] and other similar switching time reducing procedures.

In order to prevent the risk of buffer underrun or emptying and further to obtain a final buffer level after the buffer level reduction that is suitable for the particular user terminal, the determination of the second transmission rate and/or the period of time during which the second rate is employed can be performed at least partly based on input information from the user terminal. This means that the buffer level reduction of the invention can be performed based on the particular capabilities of the user terminals.

FIG. 3 is a flow diagram illustrating different embodiments of how such a determination can be implemented. The method continues from step S1 of FIG. 2. In a next step S10, the multimedia provider provides an estimate of the initial buffer level or time of the user terminal. In this embodiment and also in the other embodiments of the present invention, a buffer level of a data buffer can be expressed in terms of number of bytes the buffer contains or the duration of the buffering of data in the buffer. This means that when a buffer level is expressed as and discussed in connection with a particular buffering time this also encompasses a buffer level in terms of number of bytes and vice versa.

Different terminal models typically have different pre-defined buffering times that are selected based on the particular capability of the terminal. This means that it may be beneficial to make the buffer level decrease depending on terminal model. The multimedia provider can then use this information for obtaining a suitable buffer level reduction that is well adapted to the initial buffer level of the terminal. For example, assume a first client user terminal having an initial buffer level of four seconds and a second client user terminal having an initial buffering of three seconds. Both user terminals will re-buffer data if their buffers are emptied. Correspondingly, an appropriate buffer level reduction could be one that achieves a final buffering in the terminals of about one second. If the multimedia provider does not receive any input information of the user terminals, the provider could set the second lower transmission rate so that the buffering of the terminals would be reduced by three seconds. Although such a second transmission rate and buffering reduction would be very suitable for the first user terminal, a too large buffer level reduction is obtained for the second user terminal, which will anew re-buffer data back to the initial three seconds level. In contrast, a second transmission rate and buffer level reduction adapted for the second user terminal typically results in a non-optimal buffer level for the first user terminal. As a consequence, if the multimedia provider receives input information from the participating user terminals, the provider can perform an individualized buffer level reduction that is adapted to each particular user terminal.

This input information may in a first embodiment be a notification of the model and possible brand of the user terminal. The multimedia provider can then have access to a list of possible terminal models and brands, which specify the initial buffer level employed by such a user terminal model. Information of the model and brand is typically already transmitted in the Hyper Text Transfer Protocol (HTTP) request that is used for a multimedia channel request and channel switch request. This means that such a HTTP request can be used as information source by the multimedia provider by extracting the necessary model and brand information from the request. Another possibility could be to extract the terminal model information from the model attribute of User Agent Profile (UAProf) as used for HTTP and Wireless Application Protocol (WAP) or RTSP as, for example, described in the 3GPP document [2].

It is anticipated by the present invention that the user terminal instead could actually transmit information of its initial buffer level to the multimedia provider, thereby making a list or table look-up superfluous.

In either case, the multimedia provider then extracts the model and optionally brand information and uses the information together with the list for determining e.g. the initial buffer level of the particular user terminal. The list can, in addition to or instead, of the initial buffer level of user terminal models include information of maximum and/or minimum buffer levels of the terminal models as is discussed in more detail in connection with the embodiments disclosed in step S11 and S12 of FIG. 3.

In another embodiment of the invention as illustrated in step S11, the multimedia provider can provide an estimate of the maximum buffer level of the user terminal. It could be possible that the user terminal in practice typically only uses a portion of the capacity of its data buffer and that it potentially could buffer more data therein. In such a case, the maximum buffering capacity of the user terminal can be used for determining the second transmission rate and/or the temporary period of time of usage of the second transmission rate. For example, most terminal models can be configured to typically only utilize 80% of its buffering capacity. Information of the maximum buffer level can then be used together with this pre-defined extent of application to obtain an estimate of the initial or current buffering level of the user terminal. In this embodiment, the model list of the multimedia provider then preferably includes information of the maximum buffer capacity of the different terminal models.

In yet another embodiment of the invention as illustrated in step S12, the multimedia provider provides an estimate of the minimum buffer level of the user terminal. This minimum buffer level is the lowest buffering allowable in the user terminal. Reducing the buffering to or below this minimum level will result in re-buffering back to the pre-defined initial buffer level of the user terminal. As a consequence, performing a buffer level reduction according to the present invention in order to reduce the user-perceived lag following a channel switch is performed in such a manner that this minimum buffer level is not reached, thereby preventing the risk of data re-buffering and buffer level increase back to the initial high level. For most typical user terminal models, this minimum buffer level is zero bytes, however, it could be possible to utilize a higher margin e.g. about 0.5 s of data.

Similarly to the embodiments of S10 and S11, the model list available to the multimedia provider could then include information of the minimum allowable buffer level for the terminal models.

It is anticipated by the present invention that the embodiments discussed above in connection with steps S10 to S12 can be combined. For example, the model list of the multimedia provider could include information of the initial or maximum buffer level together with the minimum buffer level for the available user terminal models. Alternatively, the user terminal could itself directly send information of the initial/maximum and minimum buffer level.

Since the initial, maximum and minimum buffer levels are typically pre-defined values that are dependent on the capabilities of the particular user terminals, these values most often do not change during operation. As a consequence, it is enough to notify the multimedia provider once of the value(s) or information allowing provision of the value(s). This notification could be as a part of the session setup or channel switch procedure as discussed above. Actually any implementation solution that allows notification before or during the multimedia session can be utilized according to the present invention.

In a further embodiment illustrated in step S13, the multimedia provider provides an estimate of the current buffer level of the user terminal. This means that the multimedia provider can obtain status of the current buffering of the user terminal preferably during the session. The user terminal could then be configured to intermittently, periodically or based on a request from the multimedia provider send feedback of the current buffer status to the provider. A mechanism for signaling buffer level has been devised in the 3GPP document [2]. The context where this has been used before has been to optimize robustness to network problems by maximizing the buffer fullness. In the present scope, the feedback can be used in a completely new way as a way to monitor or help controlling one of the methods above to keep the buffer level at a low constant value. This embodiment can, thus, be employed for fine tuning the buffer level reduction according to the present invention down to the low appropriate value for the user terminal. For example, based on the model and brand information received during the session setup, the multimedia provider determines an initial buffer level of the user terminal. This initial level is utilized to determine the reduced transmission rate that will be temporarily employed during the session to reduce the terminal buffer. After the buffer reduction, the multimedia provider can receive feedback information of the obtained buffer level after the reduction. The provider can then use this feedback to determine whether a further buffering reduction is desired or not.

As is evident to the person skilled in the art from the discussion above, the buffer level feedback solution of step S13 can be combined with any of the embodiments of step S10 to S12 or any combination of the embodiments of step S10 to S12. The method then continues to step S2 of FIG. 2, where the multimedia provider utilize the provided buffer level information for determining the reduced transmission rate.

Furthermore, a same resulting buffer reduction does not necessarily have to be performed each and every time. For example, the buffer level reduction could also be performed based on other input information, e.g. the current radio conditions in the communications system as is schematically illustrated by step S14. Since the data buffering in the user terminal is performed to provide a safety margin to variations in transport quality (radio conditions) as well as for accommodating variations in the coding rate of the data, the data buffer reduction of the invention could be performed at least partly based on the current transport quality and coding rate. In this context, a smaller buffer level reduction of the invention is preferably conducted during poor radio conditions (low transport quality and large coding rate variations) compared to good radio conditions in order to prevent the risk of a total buffer depletion. Information or estimations of the current radio conditions, e.g. as exemplified by different quality parameters such as signal-to-noise (S/N) ratio, can be obtained from network nodes, e.g. the base station(s) that perform(s) the actual multimedia data transmission and/or the user terminal.

As was discussed in the foregoing, the multimedia provider determines a reduced transmission rate that is lower than the rendering rate of the media player in the user terminal. The rendering rate of the media player is typically defined by the time stamping of the media, i.e. one second of multimedia data is rendered in a one second period. If the user terminal instead would employ an adaptive rendering rate, which is very unusual and complex, the multimedia provider preferably receives rate input information from the terminal. Such information of the employed rendering rate can be received directly from the user terminal. Alternatively, the above-mentioned list hosted at the multimedia provider, could for the different terminal types include information of the utilized rendering rates. The multimedia provider could then utilize this information, possibly together with the buffer capacity information and feedback, in order to determine a suitable reduced transmission rate.

In a typical implementation, such an adaptive rendering rate will be dependent on and follow the current buffer level of the terminal. This means that buffer feedback information from the user terminal could be a useful source for the provider in order to determine the current rendering rate of the terminal and which reduced transmission rate that should be employed.

FIG. 4 is a flow diagram illustrating an embodiment of the lag time reducing step S3 of FIG. 2 in more detail. The method continues from step S2 of FIG. 2. In a next step S20, the multimedia provider temporarily drops data of the current multimedia channel as determined based on the second transmission rate. This means that the utilized reduced transmission rate will actually during a temporary period of time be zero and a portion of the content of the data stream of the current channel will not be transmitted to the user terminal.

In a preferred implementation of this embodiment, the multimedia provider starts the session by transmitting a few packets of data using the (high/normal) first transmission rate to the user terminal. These first packets will be entered in and buffered in the data buffer of the terminal. Once the buffering procedure has started, the provider then drops all multimedia data packets for a determined period of time. This means that no new data packets will be entered in the buffer but some of the already received data packets will leave the buffer and be rendered. The buffer level will, thus, be reduced. When an appropriate reduced buffer level is obtained, the multimedia provider anew starts sending data packets to the user terminal. The reduced buffer level will then be kept and allows a much shorter channel switching if the user subsequently would like to switch multimedia channels.

In order to make this buffer level reduction as seamless as possible for the user and user terminal, the multimedia provider preferably changes the time stamps and optionally the packet numbering of the subsequent data packets to be sent to the user in step S21. Due to this time stamp change and packet re-numbering the user terminal will not notice that any data has actually been missed.

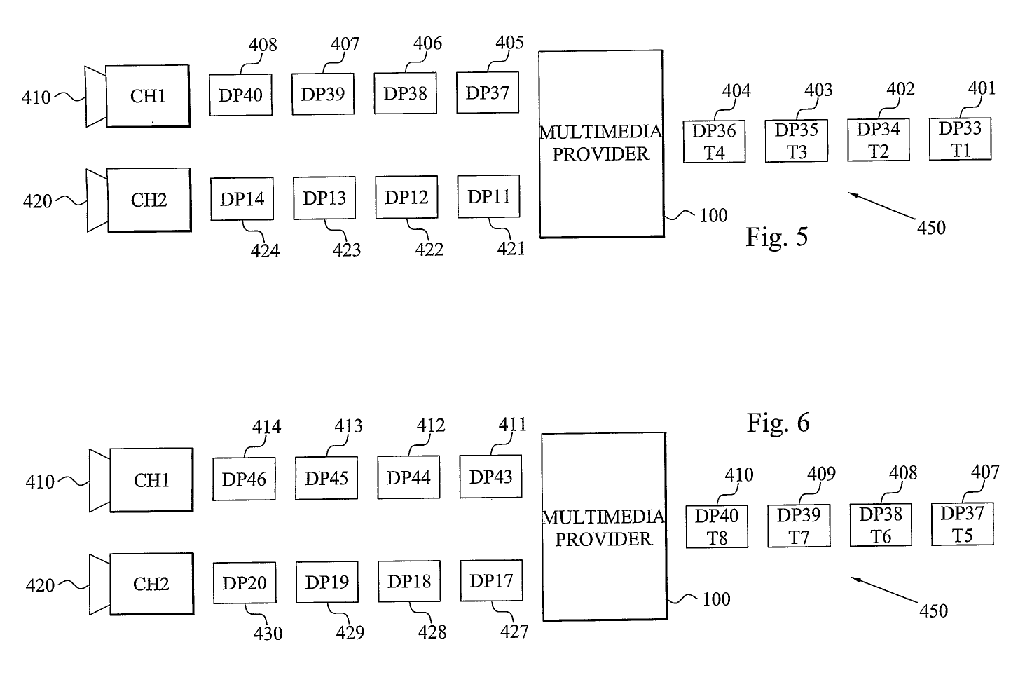

This principle is illustrated in more detail in FIGS. 5 and 6. In FIG. 5, data packets 401 to 404 are delivered from a multimedia provider 100 to a user terminal (not illustrated) in the form of a data stream 450. These data packets 401 to 404 originate from a given multimedia source 410 that represents a first multimedia channel according to the present invention. In this illustrative example, the multimedia provider 100 has access to two possible data sources 410, 420 and can, thus, offer two different multimedia channels to its connected user terminals. In FIG. 5, a first stream of data packets 405 to 408 is received from the first data source 410 and a second stream of data packets 421 to 424 is likewise received from the second source 420. Note the continuous sequence number of the data packets 401 to 408 and 421 to 424 in the different streams. The data packets 401 to 408 originating from the first data source 210 has a first sequence numbering ranging from DP33 to DP40 in the figure. The data packets 421 to 424 of the second source 220 have a second different sequence numbering from DP11 to DP14. FIG. 6 illustrates the situation after employing the lag time reducing embodiment of FIG. 4. In FIG. 6, the multimedia provider 100 has dropped two of the data packets 405, 406 that are, thus, never sent to the user terminal.

In order to provide a continuous multimedia data stream 400 to the user terminal, the multimedia provider 100 renumbers the data packets 407 to 410 so that the data packets 401 to 410 leaving the multimedia provider 100 and are sent to the same user terminal will have a continuous sequence numbering (DP33 to DP40). This means that the data packets 407 to 410 will be renumbered from DP39-DP41 to DP37-DP40 to keep the continuous numbering. The sequence renumbering is continued for the remaining data packets 411 to 414 of the channel.

More importantly than the sequence number, the time stamps T1-T8 of the data packets 401-404, 407-410 are assigned according to similar procedures as for the sequence numbering disclosed above in connection with FIGS. 5 and 6. This means that the time stamps T5-T8 of the data packets 407 to 410 are set by the multimedia provider 100 in such a way that a continuous time stamping T1-T8 of the data packets 401 to 410 is obtained and the data packet stream 450 seems continuous for the user terminal.

As is well known in the art, multimedia data may be in the form of video data and audio data. A multimedia channel that provides a multimedia stream can then be regarded as providing a video stream containing data packets comprising video data and an audio stream containing data packets comprising audio data. In such a case, the sequence numbering and time stamping according to the present invention is preferably performed on both of these data streams in order to obtain a continuous sequence numbering and time stamping of video data packets and audio data packets. In order to avoid audio play out degradations in the user terminal, the time stamp increase for the audio packets is preferably kept constant even if data packets have been deliberately dropped. This gives rise to a slight time displacement between the incoming time and the outgoing time. The time stamping of the video packets are adjusted in the same way but preferably based on the audio time stamping so as to keep the synchronization. In this context, audio data is the master. In summary, the multimedia provider assigns time stamps to the audio data packets so that the audio data stream will have continuous time stamping and assigns time stamps to the video data packets based on the time stamp assignment of the audio data packets.

Returning to FIG. 4, after the period of no data transmission, the multimedia provider continues, in step S22, to transmit the time stamp adjusted and optionally sequence re-numbered data packets at the normal first transmission rate or a third transmission rate, as discussed above. The method then ends.

This embodiment has the advantage of being simple to implement, the multimedia provider simply temporarily refrains from sending some data packets and then adjusts the time stamps of the subsequent data packets of the same multimedia channel. However, the provider typically should know when the user terminal starts receiving the packets. Otherwise there is a risk of initiating the lag time reducing procedure (packet drop) too early before data packets have started to buffer in the user terminal, which could result in total buffer depletion.

This embodiment of the invention is visually and audibly (perceptually) less attractive for the user since their will be a detectable discontinuity in the media rendering since some of the data will actually be missing. A possible improvement of this scheme is that the first data being sent is P-pictures with no coefficients in them, and correspondingly only silence is sent on the audio side. This means that if the data dropping of this embodiment is implemented early in the multimedia session, no useful data of the data channel but only coefficentless pictures and silent audio will be dropped. This, though, requires knowledge about the codecs being used, but the advantage is that there is no discontinuity in the media presentation, the perception is simply a somewhat later start.

FIG. 7 is a diagram illustrating cumulative number of bytes received and rendered as a function of time according to the embodiment of the present invention disclosed in FIG. 4. In this diagram there is a stop in the data transmission of the multimedia provider and, thus, in reception by the user terminal between 0.5 s and 3.5 s. In this case, the initial buffering time is still four seconds, but the buffer fullness (the distance between the two curves 20, 30) is only one second already after four seconds. This means that if a channel switch is requested sometimes after four seconds of the session start, the data of the new channel will only be buffered in one second in the user terminal compared to four seconds (see FIG. 1).

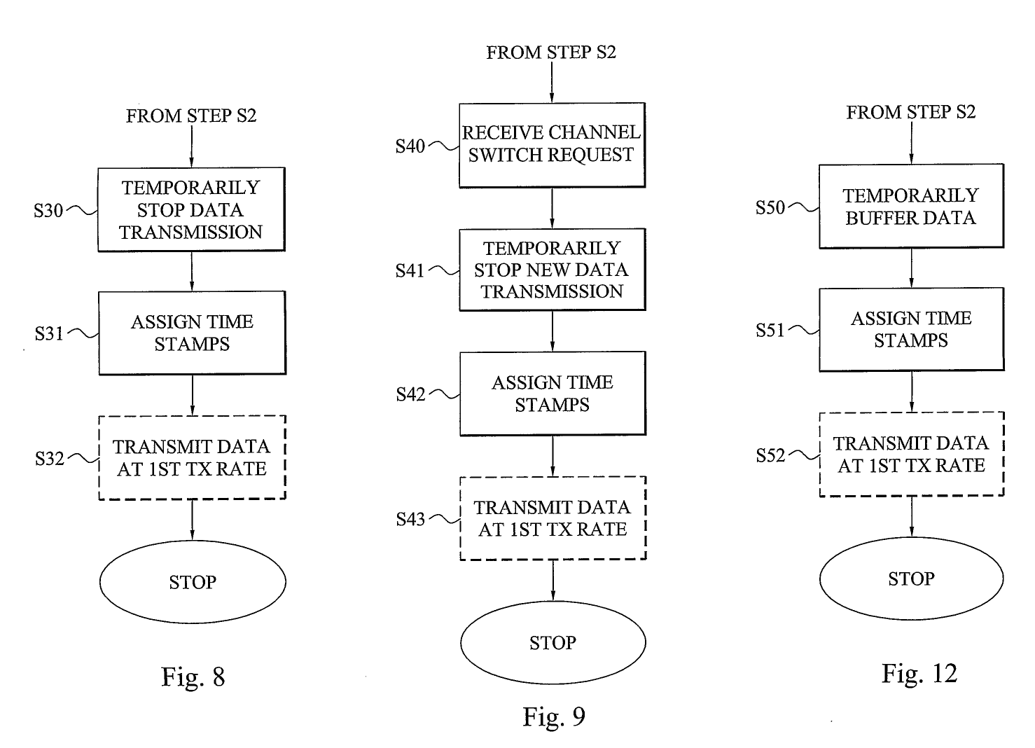

FIG. 8 is a flow diagram of another embodiment of the lag time reducing step S3 of FIG. 2 according to the present invention. The method continues from step S2 of FIG. 2. In a next step S30, the multimedia provider temporarily employs a reduced second transmission rate of 0 kB/s. However, instead of dropping data packets as in the embodiment of FIG. 4, the multimedia provider buffers the data packets in a (network) buffer. In this embodiment, some of the data buffering is moved from the user terminal side to the network side, i.e. to the multimedia provider. For example, data packets could be buffered about three seconds in the network buffer and about one second in the user terminal buffer.

When the temporary period of transmission silence has ended, data packets from the network buffer are transmitted to the user terminal. Before transmitting the data packet, or before entering them in the buffer, the multimedia provider preferably, in step S31, assigns time stamps to the data packets to form a continuous time stamping and no discontinuity in the data rendering in the user terminal. The data packets are then transmitted in step S32, which corresponds to step S22 of FIG. 4 and is not further described.

Once a channel switch request is received by the multimedia provider from the user terminal, the multimedia provider starts sending the data packets of the new channel directly to the user terminal without any buffering in the network buffer. The buffering time of the network buffer is then skipped and only the reduced buffering of the user terminal is performed. When employing the illustrative figures given above, this results in that the 3 s network buffering is omitted and only 1 s buffering in the terminal is used.

This embodiment has the advantage in that there will be no discontinuity in the media stream but results in slightly increased complexity in the network/multimedia provider, where data must be buffered. However, in this case multimedia provider have the possibility of starting the gradual decrease at a later time and does not have to adapt the timing of the terminal buffering decrease with e.g. “useless” data (P-pictures and silent audio). Diagram-wise, this embodiment looks similar to the diagram of FIG. 7.

FIG. 9 is flow diagram illustrating a further embodiment of the lag time reducing step S3 of FIG. 2 in more detail. The method continues from step S2 of FIG. 2. In a next step S40, the multimedia provider receives a request for a channel switch from the user terminal S40. This request can be generated and transmitted according to prior art techniques, e.g. according to the techniques present in the document [1]. However, instead of directly delivering data packets of the new requested channel to the user terminal, the multimedia provider temporarily stops transmitting new data of the requested channel in step S41. In a first implementation of this embodiment, the multimedia refrains from transmitting the first few data packets of the new channel to the user. During this transmission silence, the data packets of the old data channel and found in the terminal buffer will be rendered and thereby resulting in a buffering reduction. In an alternative implementation, the multimedia provider does not skip sending the first packets but instead temporarily buffers them in a network buffer. The result is similar from the buffer reduction point of view but in this implementation, the user will not miss any data but the network complexity is increased slightly.

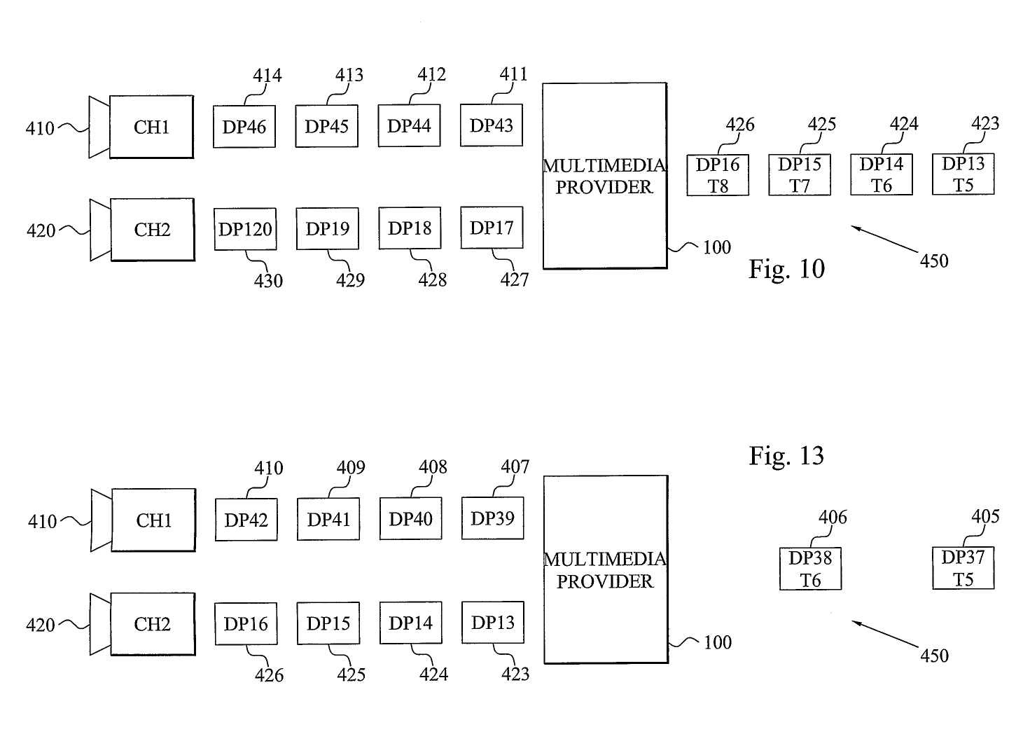

The multimedia provider preferably adjusts, in step S42, the time stamps of the data packets of the new channel so that the data stream comprising data packets of the old channel as a first portion and data packets of the new channel as a second subsequent portion will be regarded by the user terminal as one continuous stream. FIGS. 5 and 10 illustrate this principle. At the situation illustrated in FIG. 5, the multimedia provider 100 receives a request for the second multimedia channel 420 from the user terminal. According to this embodiment of the invention, instead of directly starting to deliver the first available data packet 421 of the requested channel, the multimedia provider refrains from sending the two first packets 421, 422 of the new channel in order to reduce the buffer level of the user terminal buffer. The stream 450 will instead contain the data packets 423-426 as the four first packets of the new channel. Notice though that the time stamping T5-T8 of these new packets 423-426 follows the time stamping T1-T4 of the previous data packets 401-404 in order to make the packet dropping transparent to the user terminal.

The next step S43 of FIG. 9 corresponds to step S22 and S32 of FIGS. 4 and 8, respectively, and is not further discussed.

In this embodiment the channel switch takes the same long time as employing the prior art techniques. However after the switch has been performed, the buffer level of the user terminal has been reduced. This means that any further channel switch will be performed in a much shorter period of time since the buffering of data during the switch is reduced.

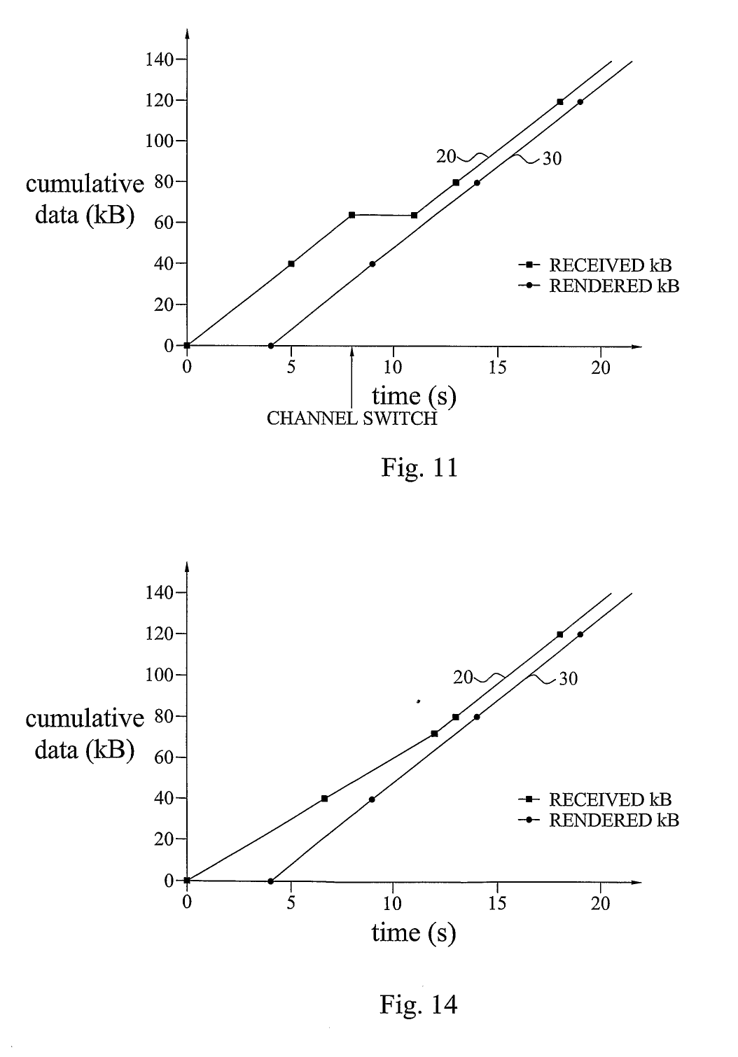

FIG. 11 is a diagram illustrating cumulative number of bytes received and rendered as a function of time according to the embodiments of the present invention disclosed in FIG. 9. In this diagram, a channel switch is performed at the time instance of eight seconds (marked by an arrow in the figure). The multimedia provider then stops sending three seconds of media data at this channel switch. The first channel switch will still involve about four seconds of buffering, according to the principles discussed above, since that is the buffer level at the user terminal at that moment. However, as the first media packets of the new channel arrive, the level is only one second, and any switches thereafter will only involve one second of buffering in the terminal.

This embodiment has the advantage of being very simple to implement, and the only requirement on the user terminal play-out is that it should have occurred before the first channel switch. The drawback is that the first switch is still long.

FIG. 12 is flow diagram illustrating yet another embodiment of the lag time reducing step S3 of FIG. 2 according to the present invention. The method continues from step S2 of FIG. 2. In a next step S50, the multimedia provider temporarily transmits the multimedia data to the user terminal at the second transmission rate. In this case the transmission rate is non-zero but lower than the rendering rate of the media player in the user terminal and furthermore lower than the normal first transmission rate. This reduced data provision rate results in that multimedia data leaves (is rendered) the data buffer of the user terminal in a faster rate than it is being replenished. As a consequence a buffer level reduction is obtained.

For live streaming, or other cases where the rate of the multimedia source cannot be changed, this solution requires that the data is buffered in the network instead of the user terminal. In such a case, this embodiment is built on similar principles as the embodiment disclosed in FIG. 8 in that the multimedia provider buffers multimedia data in a network buffer before transmission to the user terminal. However, data transmission from the multimedia provider is not totally choked during the temporary period of time as in the embodiment of FIG. 7, on the contrary the data transmission proceeds but with a reduced rate. This means that the network buffer is gradually built up simultaneous as the terminal buffer is gradually emptied in step S50.

It is anticipated by the present invention that the reduced rate does not have to be fixed during the application period but can be changed. For example, a very low transmission could initially be employed and then, e.g. based on buffer feedback information from the terminal, the multimedia provider can gradually increase the rate back to the originally employed transmission rate.

In next step S51, the multimedia provider assigns time stamps to the transmitted data packets so that a continuous time stamping is obtained. This principle is illustrated in FIGS. 5 and 13. In FIG. 13, the transmission rate has been reduced compared to the previous higher rate employed in FIG. 5. Note, though that all packets 401 to 406 of the data stream 450 have a continuous sequence numbering DP33-DP38 and time stamping T1-T6.

In a next step S52, once an appropriate low buffer level is reached in the user terminal, the multimedia provider increases the transmission rate back, preferably close, to the rendering rate to prevent total buffer emptying. The method then ends.

FIG. 14 is a diagram illustrating cumulative number of bytes received and rendered as a function of time according to the embodiment of the present invention disclosed in FIG. 12. In this illustrative example, a network buffer of three seconds is gradually built up while the user terminal buffer level is correspondingly decreased by three seconds. In this example, the user terminal is consuming (rendering) the data at the rate 8 kB/s, but the reception rate during the first 12 seconds is only 6 kB/s, since the multimedia provider is buffering 2 kB per second. After 12 seconds, the buffer level in the user terminal is down to 8 kB (1 s) while there is 24 kB (3 s) of data buffered in the network.

When the user subsequently wants to switch multimedia channel and requests a new channel, the multimedia provider simply skips the data of the old channel found in the network buffer and starts sending the new channel with no buffering in the network side. This means that the data of the new channel will only be exposed, in this example, to a total buffering of one second in the user terminal and the data will, thus, be rendered in a much shorter period of time. In this fashion, the first channel switch is fast and no extra delay is introduced. Of course, if the first channel switch occurs before the buffer level has got down to the desired value, the multimedia provider can continue buffering also in the second channel.

The advantage of this embodiment is that there is no discontinuity in the media played at the user terminal and that already the first switch may be conducted in a shorter period of time compared to the prior art techniques.

A possible issue, similar to what was discussed for the embodiment of FIG. 4, is that multimedia provider must know that the user terminal has actually started to fill up the buffer at time 0 in FIG. 14, before the provider starts to deplete the terminal buffer. However, in this case the multimedia provider has the possibility of starting the gradual decrease at a later time, since there will be no discontinuity in the media stream, i.e. there is no drop of packets.

In the illustrative embodiments of the invention discussed and disclosed above, a resulting buffer level in the user terminal of about one second has most often be given. This particular resulting buffering should, however, merely be seen as an illustrative example of a possible buffer level that can be obtained according to the teachings of the present invention. The invention is therefore not limited to reducing the buffer level down to one second but also encompasses other resulting buffering times e.g. 0.25, 0.5, 0.75, 1.25, 1.5, 1.75 and 2 seconds.

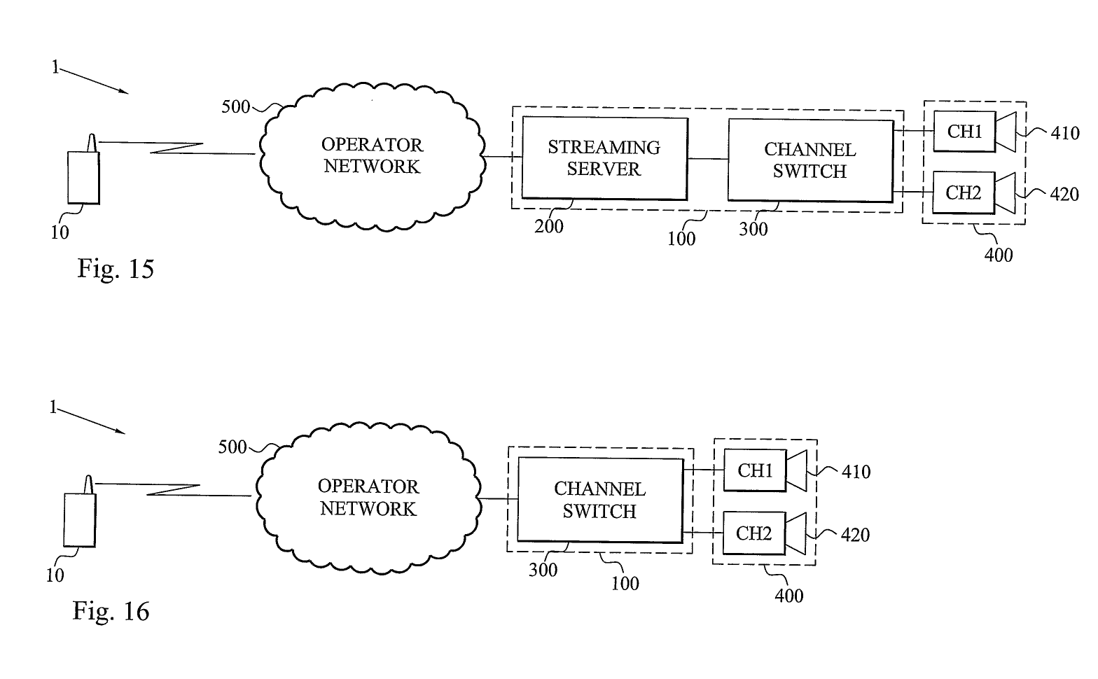

FIG. 15 is a schematic overview of a unicast-based communications system 1 according to an embodiment of the present invention. The communications system 1 basically includes a multimedia provider 100 that provides multimedia services and data to a user terminal 10 over an operator network 500 or some other wired or wireless network. The multimedia provider 100 comprises or, as is illustrated in the figure, has access to a multimedia source 400 that contains, generates or otherwise provides multimedia data from different channels 410, 420. In this illustrative example, the multimedia provider 100 has been disclosed as comprising two different units: a streaming server 200 and a channel switch 300. For such a division of the functionality of the multimedia provider 100 into different (internal) units, the streaming server 200 is preferably responsible for managing the session setup procedure, receiving channel requests and channel switch requests from the user terminal 10. This server 200 further, during the ongoing session, delivers the multimedia data from the channel switch 300 to the user terminal 10. As is evident from its name, the channel switch 300 switches multimedia channels upon a request command originating from the user terminal 10. In this channel switch, multimedia data from a new multimedia channel or source 410, 420 is now instead delivered to the streaming server 200 for forwarding over the network 500 to the user terminal 10.

FIG. 15 should merely be seen as an illustrative example of a communications system 1 according to the present invention and other system layouts are possible and within the scope of the invention. For example, the number of available multimedia channels 410, 420 does not necessarily have to be two but could be any multiple numbers, i.e. at least two, of channels 410, 420. In addition, the multimedia provider 100 could be composed of one central or distributed unit that then handles the operations of the streaming server 200 and the channel switch 300. Alternatively, the multimedia provider 100 could include more or fewer internal units, which is schematically illustrated in FIG. 16.

In FIG. 16, the streaming server has been omitted so that the channel switch 300 directly forwards the multimedia data to the user terminal 10 over the (operator) network 300. As was briefly mentioned above, the multimedia provider 100 could instead include more units, e.g. a unit that is responsible for charging for the offered multimedia service. Alternatively, such a charging unit is provided elsewhere, e.g. as a part of the operator network infrastructure 300. In addition, a dedicated application server could be a part of the multimedia provider 100. In such a case, the application server could be the unit responsible for received multimedia session setup requests and channel switch requests. This application server then command the other units 200, 300 of the multimedia provider based on these requests.

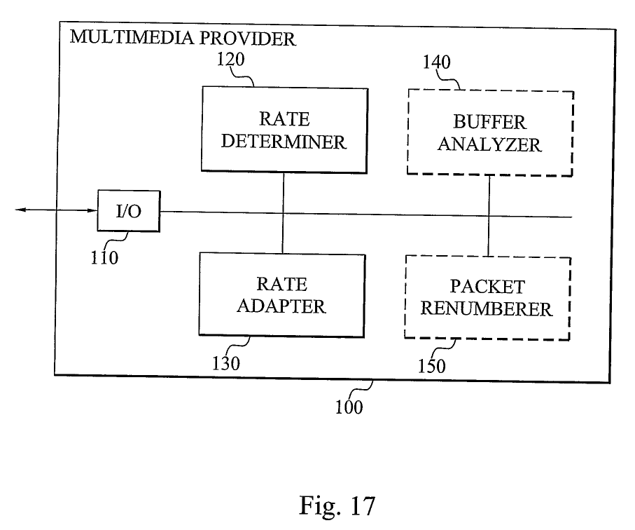

FIG. 17 is a schematic block diagram of an embodiment of a multimedia provider 100 according to an embodiment of the present invention. This provider 100 basically includes a general input and output (I/O) unit 110 that is responsible for and manages communication with external units. This means that this I/O unit 110 typically includes modulator/demodulator, coder/decoder and addressing functionality. The I/O unit 110 is in particular configured for receiving channel requests and channel switch requests from user terminals. The unit 110 is furthermore involved in the session setup negotiation with the user terminals and transmits the requested multimedia data to the terminals. In a preferred implementation of the invention, the I/O unit 110 further receives information about the (initial/maximum/minimum) buffer capacity of the terminals and/or buffer feedback information.

A rate determiner 120 is arranged in the multimedia provider 100 for determining a reduced transmission rate that will temporarily be used in order to reduce the current buffer level of a user terminal and thereby reduce the buffering time following a possible subsequent channel switch. This determined reduced rate is, on average, lower than the average normal transmission rate, which is employed by the I/O unit 110 of the multimedia provider 100 for transmitting data to user terminals. This normal rate could e.g. be dictated by and be the same as the rate of a streaming multimedia source. The reduced transmission rate is furthermore set to be lower than the media rendering rate of the user terminal, which is typically determined by the time stamping of the media.

In a preferred embodiment of the invention, the rate determiner 120 receives input information from a buffer analyzer 140 of the multimedia provider 100 and performs the rate determination at least partly based on this input information. The buffer analyzer 140 could be configured for extracting buffer capacity information from feedback messages originating from the user terminals. This capacity information could state the initial, maximum, minimum and/or current buffer level of the terminal buffer. Alternatively, the buffer analyzer 140 extracts e.g. model and brand information from messages from the user terminals and uses this information together with a pre-defined model list or look-up table/database in order to provide the buffer capacity information.

The rate determiner 120 could also receive information of the current radio conditions in the communications system and utilize this input information in the rate determination as has been discussed in the foregoing. The radio quality information could be obtained from an internal quality estimating unit (not illustrated) or from an external network unit and/or the user terminal.

The determined reduced transmission rate will then be utilized by a rate adapter 130 to reduce the user-perceived lag time following a switch of multimedia channels by partly emptying the user terminal buffer and thereby reducing the data buffering time in that buffer. Since the reduced transmission rate is lower than the data rendering rate in the terminal (as typically defined by the data packet time stamps), the buffer level of the user terminal will be lowered. In a typical embodiment, the rate adapter commands the I/O unit 110, which actually performs the data transmission, to reduce the transmission rate to the rate determined by the rate determiner 120. Alternatively, the multimedia data to transmit to the user is received from a connected (internal or external) data source (not illustrated) and is forwarded at the determined reduced rate by the rate adapter 130 to the I/O unit 110 for further transmission to the user terminal.

In a preferred embodiment of the invention, the multimedia provider 100 also includes a unit 150 that assigns time stamps and optionally renumbers the data packets transmitted to the user terminal in order to obtain a continuous data stream and continuous uniform media rendering.

The units 110 to 150 of the multimedia provider 100 may be provided as software, hardware or a combination thereof. The units 110 to 150 may be implemented together in a network node. Also a distributed implementation is possible with some of the units provided in different network nodes. It is further anticipated by the invention that at least some of the functionality and units 110 to 150 of the multimedia provider 100 may be distributed among an application server, streaming server and/or channel switch, which all could be arranged together in a single network node or can be provided in different network nodes in the unicast communications system.

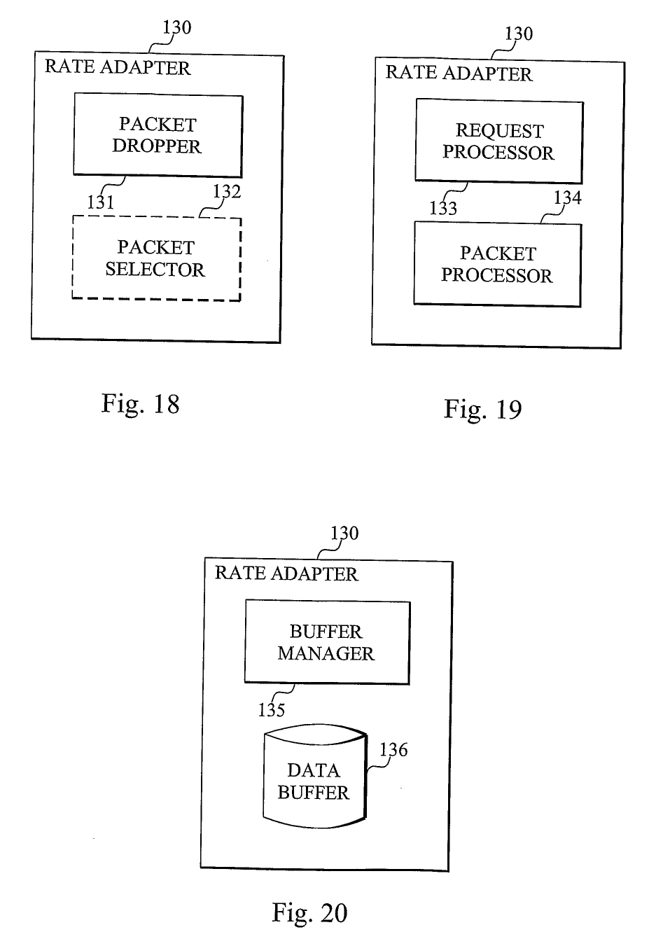

FIGS. 18 to 20 illustrate different embodiments of the rate adapter 130 of FIG. 17 in more detail. Starting with FIG. 18, this rate adapter embodiment 130 includes a packet dropper 131 and optionally a packet selector 132. The packet dropper 131 employs a zero transmission rate during a period of time as determined by the rate determiner. This means that some of the data packets from the multimedia source will actually be dropped and never reach the user terminal. The terminal will continue the rendering of the data already present in its buffer and a buffer level reduction is, thus, achieved. Since their will be a discontinuity in the multimedia as seen by the user, a packet selector 132 is preferably implemented to select those data packets to be dropped by the dropper 131 that have the smallest possible impact on the multimedia rendering. Preferred examples are data packets with coefficentless P-pictures and silent audio. After a suitable amount of data has been dropped to obtain the desired buffer level reduction, the data transmission is preceded as normal.

In order to make the data drop transparent for the media player of the user terminal, the packet renumberer of the multimedia provider preferably renumbers the data packets following the packet drop so that these packets and the packets transmitted before the drop will together have a contiguous numbering. The time stamping is also performed so that there will be no temporary stops in the media rendering in the terminal due to the data drop.

It is anticipated by the present invention that if the rate determiner estimates that a suitable reduced buffer level would be obtained by, for example, dropping three data packets, three sequential data packets could be dropped by the packet dropper 131. Alternatively, one or some of the packets could be dropped followed by transmission of one or some data packets, in turn followed by dropping some or the remaining packets, and so on.

In FIG. 19, the rate adapter 130 comprises a request processor 133 and packet processor 134. The request processor 133 receives and analyzes channel switch requests originating from the user terminal. Upon identification of such a channel switch request, the request processor 133 commands the packet processor 134 to skip sending some of the first few data packets of the new channel, or alternatively, delay sending some of the packets. This will likewise result in a buffer reduction in the user terminal since the media rendering is continued while the data replenishing is temporarily stopped.

The rate adapter 130 illustrated in FIG. 20 includes a buffer manager 135 and network data buffer 136. This rate adapter 130 is adapted for the case in which the reduced transmission rate is actually non-zero but the data forwarding rate of the multimedia source is fixed and larger than the reduced rate. In such a case, the buffer manager 135, in order to realize the transmission rate reduction, must temporarily buffer the data packets in the accessible network buffer 136. The data buffering will then be partly moved from the terminal side to the network side. Following a channel switch request, multimedia data of the new channel can be directly forwarded to the user terminal without any buffering in the network buffer 136. For that data only the short buffering in the terminal buffer has to be performed and the switching will be perceived much faster.

This rate adapter embodiment 130 could also be employed for temporary applying a zero transmission rate but without any packet dropping.

FIGS. 18 to 20 illustrate three different rate adapter embodiments 130. It is anticipated by the present invention that a multimedia provider according to the present invention can be configured to have only one of these embodiments. In alternative embodiments, the rate adapter 130 could be operated according at least two of the illustrated embodiments. For example, the rate adapter could have a packer dropper 131, a packet selector 132, a request processor 133 and a packet processor 134. This means that the rate adapter 130 could be regarded as a multi-mode unit that can be operated according to, in this case, at least two different rate adapting modes. The choice of a particular rate adapting mode to employ (FIG. 18, FIG. 19 or FIG. 20) could be based on different parameters including, the actual multimedia data that is transmitted, the model or type of user terminal, the current status of the network buffer 136 of the multimedia provider, etc.

The units 131 to 135 of the different rate adapter embodiments 130 of FIGS. 18 to 20 may be provided as software, hardware or a combination thereof. The units 131 and 132, 133 and 134 or 135 and 136 may be implemented together in the rate adapter 130. Alternatively, a distributed implementation is possible with some of the units provided elsewhere in the multimedia provider.

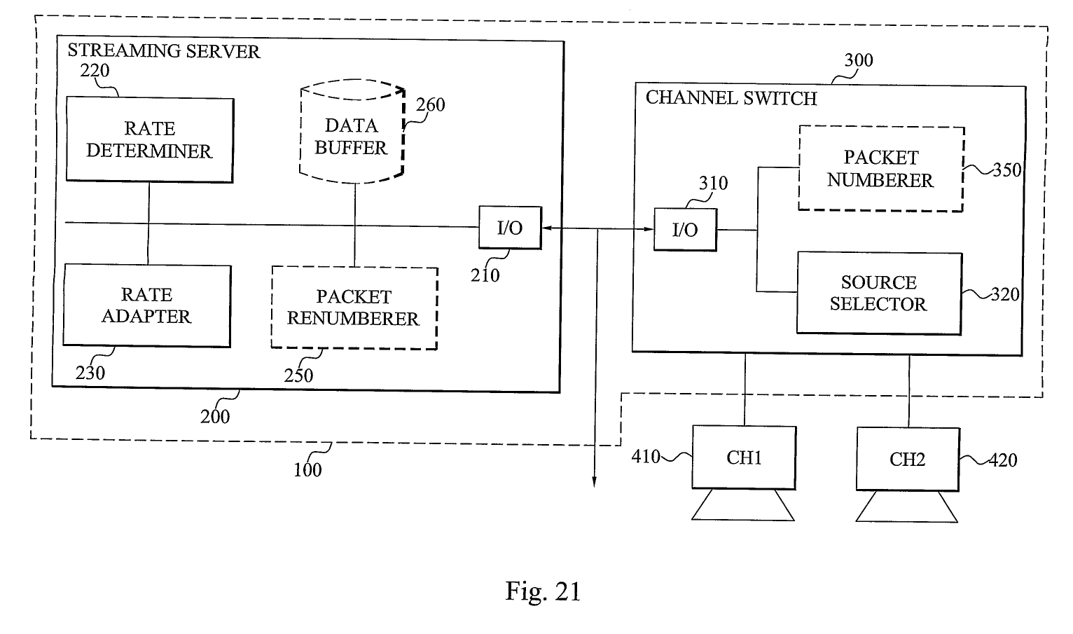

FIG. 21 is a schematic block diagram of a possible implementation of a multimedia provider 100 according to another embodiment of the present invention. In this illustrative embodiment the multimedia provider 100 is composed of a streaming server 200 and a channel switch, 300 (compare to FIG. 15).

In such an implementation, multimedia data from one or multiple data sources 410, 420 is selected for each user terminal by a source selector 320. This selector 320 typically has access to a list or table for each channel source 410, 420 that specifies those user terminal to which the multimedia data of that particular source 410, 420 should be transmitted. The multimedia data is forwarded using an I/O unit 310 of the channel switch to the streaming server 200, which is responsible for the direct transmission of the data to the user terminal by means of an I/O unit 210.

The rate determiner 220 and rate adapter 230 of the present invention are in this embodiment implemented in the streaming server 200. The operation of these two units 220, 230 is similar to the corresponding units described above in connection with FIGS. 17-20 and is not repeated herein.

A packet processing, i.e. numbering and time stamping, functionality is also preferably present in the multimedia provider 100. For example, a packet number assigning unit 350 could be arranged in the channel switch 300 for assigning sequence number to the data packets forwarded to the streaming server 200. This server 200 in turn includes a unit 250 that may renumber the data packets if required, e.g. when the rate adapter is configured drop some of the data packets of the multimedia stream. This packet processing unit 250, or some other unit in the streaming server 200, has functionality for assigning time stamps to the data packets transmitted by the I/O unit 210 to the user terminal. This time stamp assigning is preferably performed by assigning contiguous time stamps to the transmitted data packets to that a continuous packet time stamping and media rendering is obtained even if some of the packets are dropped or delayed (temporarily buffered in a network buffer 260 of the streaming server 200).

The units 210-250, 310-350 of the streaming server 200 and the channel switch 300 of the multimedia provider 100 may be provided as software, hardware or a combination thereof. The units 210-250 of the streaming server 200 may be implemented together in a network node. Also a distributed implementation is possible with some of the units provided in different network nodes. The units 310-350 of the channel switch 300 may be implemented together in a network node. Also a distributed implementation is possible with some of the units provided in different network nodes. It is further anticipated by the invention that the streaming server 200, channel switch 300 and the multimedia sources 410, 420 may be all arranged together in a single network node or can be provided in different network nodes in the unicast communications system.

A media or multimedia stream can typically be regarded as constructed of a number of frames (audio frames, video frames, etc). Some of these frames serve as synchronization points that can be used when a streaming session is started, or entered due to a switch of channel. The synchronization points are usually evenly distributed over the media stream, and their frequency is typically dependent on the bit-rate of the media.

When media streams are delivered to user terminals, the multimedia provider (often streaming server of the multimedia provider) needs to start the delivery at synchronization points in order for correct decoding in the user terminals. Except for the case when a user terminal happens to connect to the multimedia provider precisely at a synchronization point, this creates a delay equal to the time the provider has to wait for a synchronization point.

If the multimedia provider starts delivering a media stream as soon as a user terminal connects, without waiting for a synchronization point, the problem is instead that the decoders in the user terminal do not become initialized correctly, which can create annoying and confusing artifacts. This is due to media frames being coded dependent on each other. Synchronization points break this dependency.

A similar effect happens when entering or switching channels in the broadcast case with multiple channels available at the receiver. In an ordinary TV system like DVT-T, there are two intra-frames (I-frames, synchronization points) per second, which gives a low startup delay, but if the interval is longer, there will be a longer switching time.

The teachings of the present invention can be utilized together with techniques that allow starting the delivery of a synchronization point immediately as a user terminal requests a new channel and a channel switch is performed.

This can be achieved if the multimedia provider keeps a small buffer of the media stream(s). The buffer needs to be big enough to always hold at least one synchronization point.

As has been evident from the previous discussion of the present invention, some of the embodiments of the invention already utilize a network buffer in or at least accessible for the multimedia provider for the purpose of temporarily buffering multimedia data and reducing the corresponding buffering in the user terminal. The same network buffer could thus be set large enough to always include at least one synchronization point.

Another aspect relates to the emulation of synchronization points. If the number of synchronization points in the media is sparse, for example if the bit-rate is low, the amount of data needed to be buffered in the multimedia provider increases, as does the delay of the transmitted media. If this is not accepted, it can be avoided by emulating synchronization points in the server. Emulated synchronization points create artifacts in media rendered in the user terminal, but increase the overall user experience compared to starting the delivery of the media at non-synchronization points.

In the case where a video stream has the least frequent synchronization points, the synchronization point emulation could be for example one of the following:
An old intra-frame. In this case the multimedia provider always stores the latest intra-frame, and when a user terminal requests a channel switch the media delivery is started immediately, with the first video frame delivered being the old intra-frame. After the old intra-frame is delivered the multimedia provider continues delivering the current frames. It is also possible that the provider needs to skip a few frames in order to keep bandwidth constraints (due to intra-frames usually being larger (in bytes) than inter-frames).
A grey intra-frame or an intra-frame with a TV-channel logo. In this case the procedure is identical to the above case. This case has the benefit of the intra-frame being small (in bytes) (because a grey frame or a logo frame can be effectively compressed), so none of the following frames need to be skipped, and the intra-frame is transported quickly (due to being small). The drawback is the smearing of the grey color or the logo into the video stream. The multimedia provider would also need to have access to the grey frame or the logo frame by some means, since these frames are not present in the normal media stream. One solution to this problem could be to start each channel request with a grey frame or a logo frame, which the provider could then store for future use.
Using a correct intra-frame. This case is similar to the above, but in this case the multimedia has, for each video stream, access to another video stream with the same content but with all the frames encoded as intra-frames. This frame can either be created in real-time by having a decoder that decodes the stream during and feeds an intra encoder with the relevant picture. The picture may also be more compressed than the corresponding non-intra frame, by increasing the quantizer, as to decrease the number of bits needed.

An alternative is that the media source provides a second stream of intra-pictures encoded based on decoded P-pictures, which are called S-frames in the literature. This case has none of the drawbacks that the two above cases have, but it requirements on the server (and the whole system) increases.

In order to allow buffering at least one synchronization point in the network buffer, the multimedia provider should be able to identify what frames serve as synchronization points. This can be solved in a number of ways:
If the multimedia provider performs the actual media encoding, the provider always knows what frames are synchronization points.
It could be possible that the media streams are delivered to the multimedia provider and the provider has knowledge of the media transport protocols as well as the media encoding standards. The multimedia provider can then parse the incoming media streams and decode the headers of the frames in order to deduce which frames are synchronization points. In most cases the encoding of frame headers is not complex. One of the simplest cases is to find the Network Adaptation Layer Unit (NALU) type field in the Real Time Protocol (RTP) payload for an Advanced Video Codec (AVC) stream. The NALU type field will directly identify if the RTP packet contain a NALU being part of an Instantaneous Decoding Refresh (IDR) frame.
If the media streams are delivered to the multimedia provider, the packets containing the synchronization points can be marked. For example, if delivered over IP, the IPv4 Type of Service (TOS) [3], IPv6 Traffic Class, or IPv6 Flow Label [4] in the IP-header can be used to mark frames that are synchronization points. Marking in a higher layer, for example in the RTP protocol is also possible.
For video streams where intra-frames serve as synchronization points, the intra-frames can often be identified by looking at the size of the frames. This is because intra-frames are usually larger than inter-frames.
In an error-free environment, where the frequency of synchronization points is constant, the frame number is enough to recognize a synchronization point.

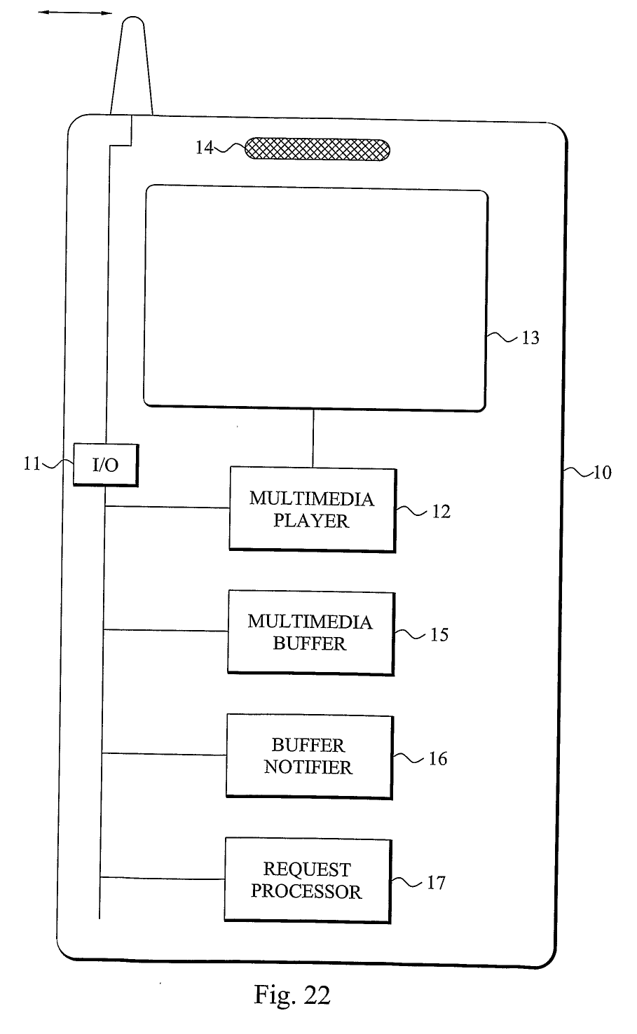

FIG. 22 is a schematic block diagram of a user terminal 10 according to the present invention. This user terminal 10 comprises an I/O unit 11 for communicating with a multimedia provider. This I/O unit 11 is in particular adapted for transmitting a channel request and a channel switch request to the provider. The I/O unit 11 also receives the multimedia data from the provider.

The user terminal 10 further includes a multimedia or media player 12 for rendering the received multimedia data. This multimedia player 12 is preferably in communication with a display screen 13 and a loudspeaker 14 of the terminal 10 for displaying and playing out the media thereon. The media player 12 is in connection with a multimedia buffer 15, in which the data packets received by the I/O unit 11 are entered and buffered before forwarded to the player 12 for rendering. The idea of the present invention is to reduce the data buffering that is performed in this multimedia buffer 15 by modulating the transmission rate of the data forwarding to be lower than the rendering rate of the media player 12.

The user terminal 10 preferably also includes a buffer notifier 16 that provides information that is transmitted by the I/O unit 11 to the multimedia provider and allows the provider to estimate the buffering capacity of the user terminal 10. The notifier 16 could provide information of the initial, maximum, minimum and/or current buffer level of the multimedia buffer 15. Alternatively, the buffer notifier 16 simply includes, e.g. in a session setup request or channel switch request, terminal model information.

A request processor 17 is implemented in the user terminal 10 for generating the channel and channel switch requests. The request processor 17 could include information obtained by the buffer notifier 16 in the requests transmitted to the multimedia provider.

The units 11, 12, 15-17 of the user terminal may be provided as software, hardware or a combination thereof.

It will be understood by a person skilled in the art that various modifications and changes may be made to the present invention without departure from the scope thereof, which is defined by the appended claims.

### REFERENCES

[1] International application no. PCT/SE2005/001768
[2] 3GPP TS 26.234 v6.5.0, 3^{rd} Generation Partnership Project; Technical Specification Group Services and System Aspects; Transparent end-to-end Packet switched Streaming Service (PSS); Protocols and codes
[3] Postel, J., Internet Protocol, Darpa Internet Program Protocol Specification, RFC 791, September 1981
[4] Deering, S. and R. Hinden, Internet Protocol, Version 6 (IPv6) Specification, RFC 1883, December 1995

1. A method of reducing a user-perceived time of switching multimedia channels in a communications system comprising a multimedia provider providing multimedia data of a first multimedia channel to a user terminal at a first transmission rate, said method comprising the steps of:
said multimedia provider determining a second transmission rate that is lower than said first transmission rate and is lower than a multimedia data rendering rate of said user terminal; and
said multimedia provider actively reducing a lag time for rendering multimedia data of a second multimedia channel in said user terminal following a switch from said first multimedia channel to said second multimedia channel by temporarily transmitting multimedia data to said user terminal at said determined second transmission rate in order to reduce a time period of buffering multimedia data in said user terminal.

2. The method according to claim 1, wherein said step of actively reducing said lag time comprises the step of said multimedia provider temporarily transmitting multimedia data to said user terminal at said determined second transmission rate in order to reduce the buffer level of a multimedia data buffer of said user terminal from a first buffer level to a second smaller buffer level.

3. The method according to claim 1, wherein said determining step comprises the step of said multimedia provider determining said second rate based on at least one of:
information of an estimated initial buffering time of said user terminal;
information of a maximum buffer level of a multimedia data buffer of said user terminal;
information of a minimum allowed buffering time of said user terminal; and
information of an estimated current buffer level of said multimedia data buffer of said user terminal.

4. The method according to claim 1, wherein said determining step comprises the step of said multimedia provider determining said second rate based on a quality estimate representing the current radio conditions of said communications system.

5. The method according to claim 1, wherein said multimedia provider comprises:
a streaming server comprising a multimedia data buffer; and
a multimedia source having a fixed rate for forwarding multimedia data to said streaming server, said step of actively reducing said lag time comprises the step of said streaming server buffering multimedia data in said multimedia data buffer before transmitting said multimedia data to said user terminal to temporarily reduce the multimedia data transmission rate from said first transmission rate to said second transmission rate.

6. The method according to claim 5, further comprising the step of said streaming server transmitting, to said user terminal and based on a request for a channel switch from said first multimedia channel to said second multimedia channel, multimedia data of said second multimedia channel at said first rate without buffering said multimedia data of said second multimedia channel in said multimedia data buffer.

7. The method according to claim 1, wherein multimedia data is transmitted as a multimedia data stream of data packets from said multimedia provider to said user terminal, said step of actively reducing said lag time comprises the step of said multimedia provider temporarily refrains from sending a portion of said data packets of said multimedia data stream.

8. The method according to claim 7, wherein said data packets of said portion of data packets comprise coefficientless P-picture data and silent audio data.

9. The method according to claim 1, wherein said step of actively reducing said lag time comprises the step of said multimedia provider temporarily stops sending multimedia data to said user terminal.

10. The method according to claim 1, wherein said step of actively reducing said lag time comprises the steps of:
said multimedia provider receiving a request of a channel switch from a third multimedia channel to said first multimedia channel from said user terminal; and
said multimedia provider temporarily stops sending multimedia data of said first channel to said user terminal following said channel switch from said third multimedia channel to said first multimedia channel.

11. The method according to claim 1, wherein multimedia data is transmitted as a multimedia data stream of data packets from said multimedia provider to said user terminal, each data packet is associated with a sequence number, said method further comprising the step of said multimedia provider assigning sequence numbers to data packets so that said data packets of said multimedia data stream have a continuous sequence numbering.

12. The method according to claim 1, wherein multimedia data is transmitted as a multimedia data stream of data packets from said multimedia provider to said user terminal, each data packet is associated with a time stamp, said method further comprising the step of said multimedia provider assigning time stamps to data packets so that said data packets of said multimedia data stream have a continuous time stamping.

13. The method according to claim 1, further comprising the step of said multimedia provider switching multimedia channel from said first multimedia channel to said second multimedia channel and transmitting multimedia data of said second multimedia channel to said user terminal at an instance where a multimedia data stream of said second multimedia channel comprises intra picture data.

14. The method according to claim 13, wherein said multimedia provider comprises a data buffer arranged for continuously storing data corresponding to at least one complete intra picture of said second multimedia channel.

15. An arrangement for reducing a user-perceived time of switching multimedia channels, said arrangement comprises:
a transmitter for transmitting multimedia data of first multimedia channel to a user terminal at first transmission rate;
means for determining a second transmission rate that is lower than said first transmission rate and is lower than a multimedia data rendering rate of said user terminal; and
means for reducing a lag time for rendering multimedia data of a second multimedia channel in said user terminal following a switch from said first multimedia channel to said second multimedia channel by commanding said transmitter to temporarily transmit multimedia data to said user terminal at said determined second transmission rate in order to reduce a time period of buffering multimedia data in said user terminal.

16. The arrangement according to claim 15, wherein said reducing means is configured for commanding said transmitter to temporarily transmit multimedia data to said user terminal at said determined second transmission rate in order to reduce the buffer level of a multimedia data buffer of said user terminal from a first buffer level to a second smaller buffer level.

17. The arrangement according to claim 15, wherein said determining means is configured for determining said second transmission rate based on at least one of:
information of an estimated initial buffering time of said user terminal;
information of a maximum buffer level of a multimedia data buffer of said user terminal;
information of a minimum allowed buffering time of said user terminal; and
information of an estimated current buffer level of said multimedia data buffer of said user terminal.

18. The arrangement according to claim 15, wherein said determining means is configured for determining said second transmission rate based on a quality estimate representing the current radio conditions of a radio communications system in which said arrangement is operated.

19. The arrangement according to claim 15, wherein said arrangement comprises:
a streaming server comprising a multimedia data buffer and said transmitter; and
a multimedia source for forwarding multimedia data to said streaming server at a fixed rate, said reducing means being implemented in said streaming server and being configured for buffering multimedia data in said multimedia data buffer before commanding said transmitter to transmit said multimedia data to said user terminal to temporarily reduce the multimedia data transmission rate from said first transmission rate to said second transmission rate.

20. The arrangement according to claim 19, wherein said reducing means is configured for commanding said transmitter to transmit, to said user terminal and based on a request for a channel switch from said first multimedia channel to said second multimedia channel, multimedia data of said second multimedia channel at said first rate without buffering said multimedia data of said second multimedia channel in said multimedia data buffer.

21. The arrangement according to claim 15, wherein said transmitter transmits multimedia data as a multimedia data stream of data packets to said user terminal, said reducing means is configured for commanding said transmitter to temporarily refrain from sending a portion of said data packets of said multimedia data stream.

22. The arrangement according to claim 21, wherein said data packets of said portion of data packets comprise coefficientless P-picture data and silent audio data.

23. The arrangement according to claim 15, wherein said reducing means is configured for commanding said transmitter to temporarily stop sending multimedia data to said user terminal.

24. The arrangement according to claim 15, wherein said reducing means is configured for commanding, upon reception of a request of a channel switch from a third multimedia channel to said first multimedia channel from said user terminal, said transmitter to temporarily stop sending multimedia data of said first multimedia channel to said user terminal following said channel switch from said third multimedia channel to said first multimedia channel.

25. The arrangement according to claim 15, wherein said transmitter transmits multimedia data as a multimedia data stream of data packets to said user terminal, each data packet is associated with a sequence number, said arrangement further comprising means for assigning sequence numbers to data packets so that said data packets of said multimedia stream have a continuous sequence numbering.

26. The arrangement according to claim 15, wherein said transmitter transmits multimedia data as a multimedia data stream of data packets to said user terminal, each data packet is associated with a time stamp, said arrangement further comprising means for assigning time stamps to data packets so that said data packets of said multimedia data stream have a continuous time stamping.

27. The arrangement according to claim 15, further comprising means for switching multimedia channel from said first multimedia channel to said second multimedia channel, said switching means is configured for performing said channel switch at an instance where a multimedia data stream of said second multimedia channel comprises intra picture data.

28. The arrangement according to claim 27, further comprising a data buffer arranged for continuously storing data corresponding to at least one complete intra picture of said second multimedia channel and said switching means is configured for accessing said data corresponding to at least one complete intra picture during said channel switch.

29. A network node comprising an arrangement according to claim 15.
